(19) United States
(12) Patent Application Publication
(10) Pub. No.: US 2009/0017372 A1
(43) Pub. Date: Jan. 15, 2009

(54) RECHARGEABLE BATTERY

(76) Inventors: Marcin REJMAN, Waiblingen (DE); Wolf Matthias, Stuttgart (DE); Thorsten Seidel, Remseck am Neckar (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/166,381

(22) Filed: Jul. 2, 2008

(30) Foreign Application Priority Data
Jul. 9, 2007 (DE) 10 2007 031 859.8

(51) Int. Cl. H01M 2/24

(52) U.S. Cl. 429/160

(57) ABSTRACT

The invention relates to a rechargeable battery for handheld electromechanical tools, having a plurality of battery cells that are connected electrically to one another by means of flat electrical cell connectors, wherein in a region of the rechargeable battery in which two cell connectors overlap, an electrical insulator is fixed to a cell connector of an electrical cell bypass. The invention further relates to an electromechanical tool, in particular a cordless screwdriver, power drill, circular saw, jigsaw, power sander, or garden tool, having a rechargeable battery according to the invention.

### CROSS-REFERENCE TO RELATED APPLICATIONS

This application is based on German Patent Application No. 10 2007 031 859.8 filed on Jul. 9, 2007, upon which priority is claimed.

### BACKGROUND OF THE INVENTION

1. Field of the Invention

The invention relates to a rechargeable battery for landheld electromechanical tools, which has a plurality of battery cells connected electrically to one another. The invention also relates to an electromechanical tool having a rechargeable battery of the invention.

2. Description of the Prior Art

Electromechanical tools is a term for all handheld portable electrically operated hand tools in which a motor is a usually inseparable component of the tool. It applies for instance to power drills, cordless screwdrivers, circular saws and jigsaws, right-angle sanders and similar power sanders, and, depending on the design, various garden tools, such as electrical hedge clippers. Rechargeable or nonrechargeable batteries for such tools should have the highest possible capacity, the least possible weight, and require the least possible amount of space and furthermore should be capable of being manufactured economically.

Electrical connections among battery cells or battery pack cells inside a rechargeable battery are as a rule designed such that electrical cell connectors do not overlap. The avoidance of overlapping cell connectors sometimes makes additional cord connections inside the rechargeable battery necessary. As a result, more space inside the rechargeable battery is occupied, and this space could otherwise be used in other ways for instance for larger battery cells, or for a rechargeable battery that is smaller overall. Moreover, short cords that serve to circumvent or avoid overlaps of cell connectors are in particular hardly feasible technologically, or if feasible, then only at major effort and expense for assembly.

German Patent DE 100 03 740 C1 discloses a battery within a heat dissipator, and in the battery, a plurality of battery cells are interconnected. These battery cells are connected parallel, and each three battery cells are electrically connected by means of one cell connector and form a battery cell packet. The battery cell packets of the battery are electrically connected by means of current bridges and connected in series. As a result of the series connection, there are no overlapping cell connectors or current bridges. For dissipation of heat generated in the battery, a flat cooling plate is provided on at least one face end of the battery; this plate is at least indirectly in thermal contact with the cell connectors and current bridges.

Rechargeable batteries and battery pack cells are becoming increasingly compact, and under some circumstances overlapping of electrical cell connectors cannot always be avoided. Cord connections required for the purpose use up space inside the rechargeable battery and are cost-intensive to manufacture.

### OBJECT AND SUMMARY OF THE INVENTION

It is therefore an object of the invention to disclose an improved rechargeable battery. In particular, it is an object of the invention to realize a space-saving electrical cell connection inside the rechargeable battery, where overlapping of cell connectors can be allowed, and thus to disclose a cell connector and a rechargeable battery with such a cell connector. It is furthermore an object of the invention to realize all electromechanical tool with a rechargeable battery according to the invention.

The objects of the invention may be attained by means of a rechargeable battery and an electromechanical tool.

According to the invention, a preferably flat electrical cell connector for a rechargeable battery is made available, and by means of the cell connector, at least two battery cells of the rechargeable battery can be connected electrically to one another. An electrical insulator is secured to the cell connector of the invention in at least one region where the cell connector bypasses a further cell connector; together, the cell connector and the electrical insulator create the electrical cell bypass according to the invention. In other words, the cell connector of the cell bypass has an electrical insulator in the portion or portions where there is the risk of a short circuit to one or more other cell connectors.

In a preferred embodiment of the invention, the electrical insulator is a plastic that is integrally molded or extrusion-coated or back-injected onto the cell connector by means of an injection molding process. Preferably, only that portion of the cell connector where the cell connector bypasses the other cell connector is provided with the electrical insulator. As a result, the cell connector and hence the rechargeable battery as well can be as small as possible.

The rechargeable battery of the invention and the cell connector of the invention are inexpensive, economical, easy to assemble, and reliable, since direct cord connections between battery cells can be avoided. The cell connector is easy to design with respect to its geometry and its temperature and electrical insulation behavior. Moreover, by varying the geometry of the electrical insulator, the cell connector of the invention is safe and reliable, since it is adaptable to the requirements that exist inside the rechargeable battery.

In a preferred embodiment of the invention, the cell connector of the cell bypass is constructed like a conventional cell connector at a contact portion and it can be welded to a battery cell. The contact portion is preferably bifurcated and is secured to the battery cell by means of two spot welds.

A second contact portion of the cell connector is either constructed like the first contact portion or is embodied as a tab. It is furthermore possible, on a cell connector having conventional contact portions, to provide tabs on one end or in a middle region of the cell connector. By means of the current-carrying tab, it is possible to dispense with wiring of the battery cells, or by means of an electrical connection of a cord to a tab for a cord (cord tab) to simplify the wiring. Preferably, the tab is bent in the direction toward a battery cell, so that as little additional space as possible is used.

In preferred embodiments of the cell bypass of the invention, the electrical insulator is embodied as a securing portion on a side remote from the cell connector. In other words, by means of a securing portion integrally shaped into the electrical insulator it is possible to position the cell bypass quickly and easily inside the rechargeable battery; after that, a portion of the cell connector, for instance embodied as a conventional contact portion, is welded to a battery cell. If a cable tab is present, then it is preferable to perform the electrical connection of the cord to the tab before mounting the cell bypass of the invention on the battery cell or cells.

In preferred embodiments of the invention, the electrical insulator has two securing portions; the first securing portion is seated on one battery cell, and the second securing portion is seated on a battery cell directly adjacent to it. As a result, the cell bypass of the invention is seated securely on two battery cells, so that welding of a contact portion to a battery cell is simple to do. Each securing portion is preferably provided at least in part as an imprint or as a 3D negative of a face-end portion of a battery cell in the electrical insulator of the cell bypass. It is furthermore possible to lock or glue the applicable securing portion to a battery cell.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a 3D view of four battery cells, with an electrical cell bypass according to the invention seated on them;

FIG. 2 is a view similar to FIG. 1, with the cell bypass shown in an exploded view;

FIG. 3 shows the cell bypass in perspective from below;

FIG. 4 shows the cell bypass in perspective from above;

FIG. 5 is a central cross section through the cell bypass disposed on a battery cell;

FIG. 6 is a side view of an additional embodiment of the cell bypass; and

FIG. 7 is a side view of a farther embodiment of the cell bypass.

### DESCRIPTION OF THE PREFERRED EMBODIMENTS

The invention will be described in detail below in terms of a rechargeable battery for handheld electromechanical tools. However, the invention should not be limited to such handheld tools but instead should pertain to rechargeable batteries in general. Hence the invention can be applied for instance to rechargeable batteries for motor vehicles with internal combustion engines or for drives of electric motor vehicles. It is moreover possible for instance to use the invention for rechargeable batteries for portable electronic devices, drives such as drives in model building, and for cell phones, cameras, and the like.

When the term cell connector is used below, it is understood that it also includes the term cell terminal for a pole of the rechargeable battery; that is, the invention also relates to that portion of a rechargeable battery where the cell connector, in the form of a rechargeable battery pole, is visible on the outside of the rechargeable battery.

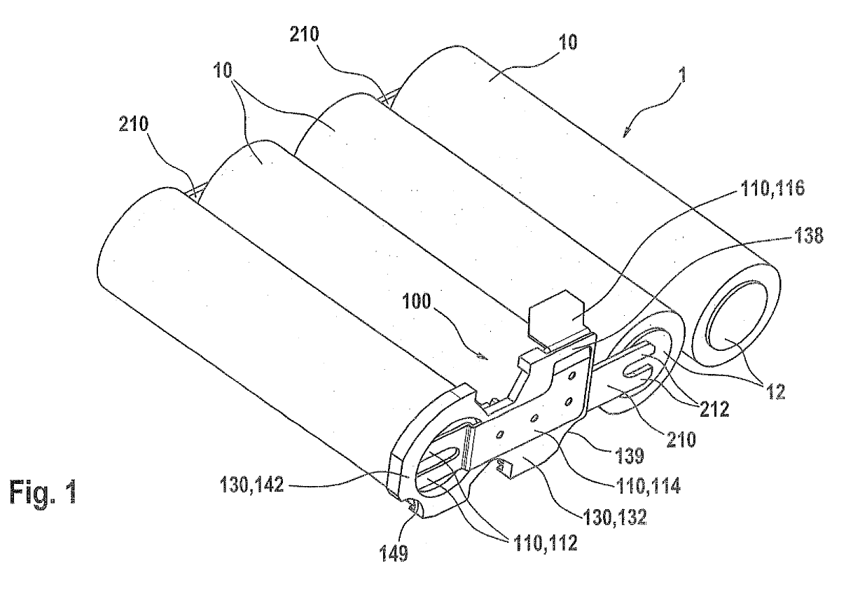

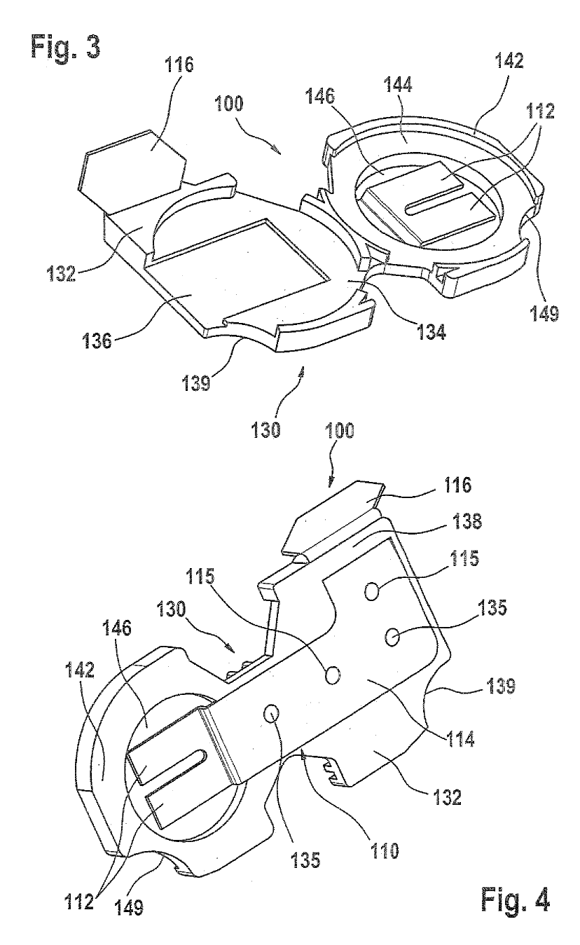

FIG. 1 shows a rechargeable battery 1 or a rechargeable battery string 1 or a rechargeable battery packet 1 or a battery 1; a housing of the rechargeable battery 1 is not shown. The rechargeable battery 1 has four battery cells 10 connected in series with one another, and an electrical connection of the battery cells 10 is effected via three conventional electrical cell connectors 210. FIG. 1 moreover shows an electrical cell bypass 100 according to the invention, which is seated on the face end on two battery cells 10 located side by side. It is understood that it is also possible to provide the rechargeable battery 1 with more or fewer battery cells 10, and to connect the battery cells electrically in series or parallel as needed. The cell bypass 100 according to the invention can furthermore be seated on only one battery cell or on more than two battery cells 11 and/or can have other configurations besides what is shown in the drawings, particularly in FIGS. 3, 6 and 7.

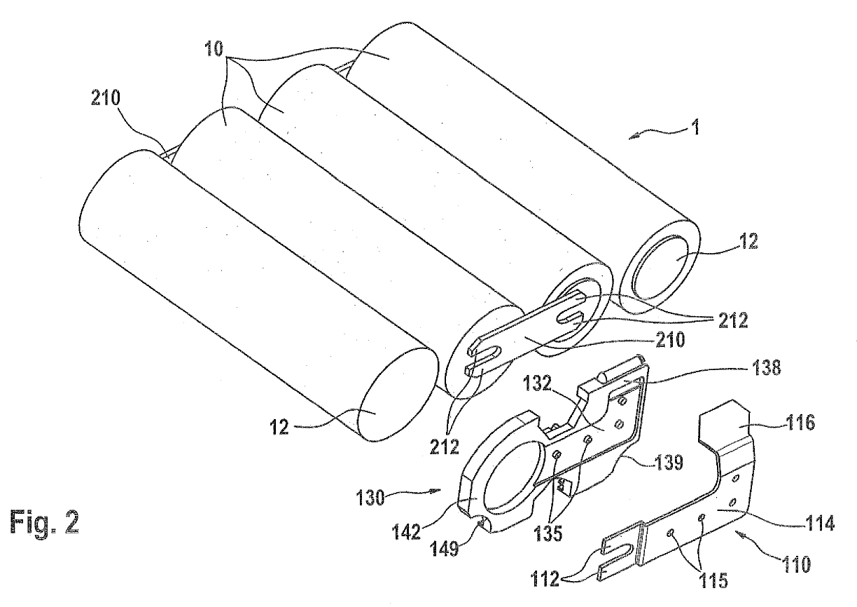

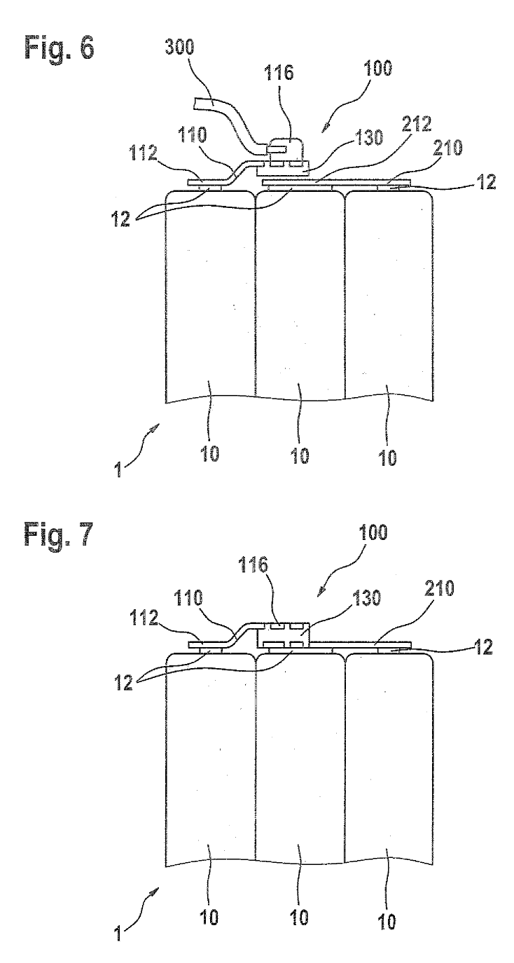

The electrical cell bypass 100 of the invention essentially has an electrical cell connector 110 and an electrical insulator 130; the electrical insulator 130 insulates the cell connector 110 electrically, at least in some portions. FIG. 2 shows the cell bypass 100 of the invention in an exploded view outside the battery cells 10. In the exemplary embodiment shown, the cell connector 110 is a flat, strip like electrical conductor 1107 which has an angled or L-shaped configuration. The cell connector 110 has two contact portions 112, 116, to which electrical contacts, such as poles 12 of a battery cell 10 or a conductor of a cord 300 (see FIG. 6), can be connected electrically. The contact portion 112 serves preferably to provide electrical contact with one pole 12 of the battery cell 10. The contact portion 112 here is preferably bifurcated or embodied in a forklike fashion; one spot weld is made at each of the two portions separated from one another by a gap, and the spot weld electrically connects the contact portion 112 to the applicable pole 12. The other contact portion 116, in the present exemplary embodiment, is embodied as a tab 116, to which a further tab 116 or the cord 300 can be connected electrically. In a center portion 114, the cell connector 110 has recesses 115, preferably through recesses 115, through which corresponding protrusions 135 of the electrical insulator 130 can pass inward or all the way through, thereby causing the cell connector 110 to be fixed to the electrical insulator 130.

In the present exemplary embodiment, the electrical insulator 130 has two securing portions 132, 142. By means of the securing portion 132, which is also called the insulation portion 132, the cell connector 110 is secured to the electrical insulator 130 on the one hand, and on the other, the cell bypass 100 is thus seated on a face end of a battery cell 10. The securing portion 142 is furthermore embodied such that on the one hand, electrical contacting of one pole 12 of a battery cell 10 is assured by the contact portion 112 of the cell connector 110, and on the other, seating of the cell bypass 100 on a battery cell 10 is possible.

FIGS. 3 and 4 show the cell bypass 100 of the invention in its state ready for use. The electrical insulator 130 here is preferably integrally molded or back-injected onto the cell connector 110 by means of an injection molding process.

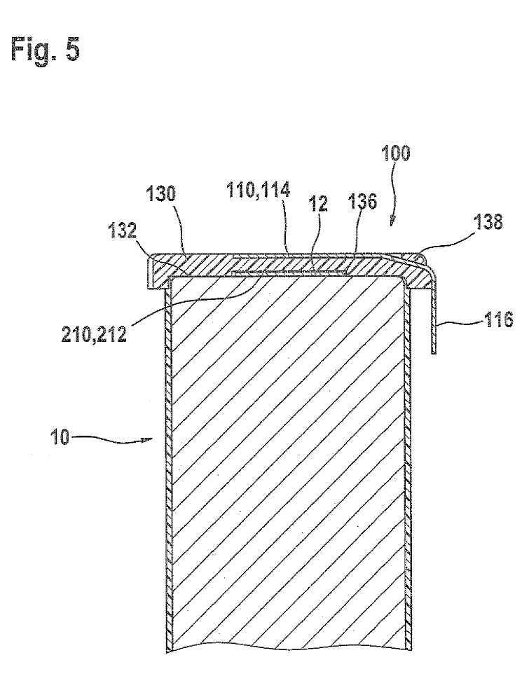

In FIG. 3, the two securing portions 132, 142 can readily be seen. The securing portion 132 has an at least partially circular pole recess 134, by means of which the cell bypass 100 is seated on one pole 12 of a battery cell 10. A recess 136 for a cell connector 210, or for a contact portion 212 of a cell connector 210, can be provided on the bottom of the pole recess 134. This can be seen in cross section in FIG. 5.

The securing portion 142 adjoining the securing portion 132 is essentially circular-annular in construction and has a central through recess 146. The contact portion 112 of the cell connector 110 protrudes through this continuous recess 146, and as a result the contact portion 112 can electrically contact the pole 12 of the battery cell 10. The securing portion 142 has an at least partially circular pole recess 144, by means of which the cell bypass 100 can be seated on a pole 12 of a battery cell 10.

Overall, the electrical insulator 130 is dumbbell-shaped, as can be seen readily in FIG. 3. The two securing portions 132, 142 touch and are preferably joined into one piece as they may be made of the same material as one piece.

The tab 116 protrudes laterally from the securing portion 132. Preferably, the tab 116 is bent out of a plane of the electrical insulator 130, or a plane of the cell connector 110, in such a way that in an installed state it is bent toward a battery cell 10. This can be readily seen in FIGS. 1 and 2. Another embodiment, with a tab 116 bent away from a battery cell 10, is shown in FIG. 6.

By means of the two securing portions 132, 142, which are preferably placed on directly adjacent battery cells 10, a fixation of the cell bypass 100 in three rotational and two translational directions inside the rechargeable battery 1 is possible. That is, the cell bypass 100 can be pulled off two battery cells 10 in only one translational direction. A fixation in that direction can be effected on the one hand via a housing of the rechargeable battery 1 and on the other via the spot weld or other fastening of the contact portions 112, 116 to the battery cells 10. It is furthermore possible to glue and/or lock the cell bypass 100 to the battery cell or cells 10.

In the embodiment of the invention shown in FIGS. 1 through 5, the cell connector 110, in a peripheral region of its tab 116, passes through the electrical insulator 130. This can be readily seen in FIGS. 4 and 5, in which a locking bar 138 of the electrical insulator 130 fits over the cell connector 110 and clamps to a portion located below it of the electrical insulator 130. Directly adjacent to this, the tab 116 emerges from the electrical insulator 130. The cell connector 110 furthermore preferably has continuous recesses 115, which liquid plastic can enter into as the electrical insulator 130 is being integrally molded on, and thus by means of hardened protrusions 135, the cell connector 110 is additionally solidly connected to the electrical insulator 130. In the present example, three continuous recesses are provided on a longer portion of the center portion 114, and one continuous recess 115 is provided on a shorter portion, which is located in the vicinity of the tab 116.

The electrical insulator 130 can also have recesses 139, 149 on its edges, in order to make the space required by the rechargeable battery 1 as slight as possible. That is, the electrical insulator 130, at those points where later space is required, for instance for a housing of the rechargeable battery 1, has suitable recesses 139, 149. Preferably, these recesses 139, 149 are provided in corner regions of the electrical insulator 130 or corner regions of the rechargeable battery 1. Thus the recess 149 shown in FIGS. 1 and 4, for instance, of the securing portion 142 serves to allow the housing to be as close as possible to a battery cell 10 of the rechargeable battery 1, and thus serves to make the rechargeable battery 1 as small in size as possible.

FIG. 5 shows a battery cell 10 in section, with a cell bypass 100 according to the invention seated on it; the cell bypass 100 is shown in section in a region of its securing portion 132. It can readily be seen how the cell connector 110, with its center portion 114, and the second cell connector 210, in the region of its contact portion 212, overlap and are separated electrically from one another by the electrical insulator 130. In this overlapping region, the electrical insulator 130 is embodied as thin and strip like. Because at least in this region the cell connector 110 has the electrical insulator 130, and the cell connectors 110, 210 are embodied as strip like and flat, the cell bypass 100 can be embodied in as flat a form as possible on one end of a battery cell 10. In FIG. 5, the tab 116 bent in the direction of the battery cell 10 can also be readily seen.

FIGS. 6 and 7 show two further embodiments of the cell bypass 100 of the invention.

FIG. 6 shows an embodiment with a cord 300 connected electrically to the tab 116; the cable tab 116 is bent away from the battery cell 10. The cell bypass 110 here can have either no securing portions or one securing portion or even two securing portions 132, 142. In the present embodiment of FIG. 6, the cell bypass 100 has no pronounced securing portion 132, 142; instead, it is simply seated with the electrical insulator 130 at the top on the cell connector 210, or its contact portion 212. As a result, space can be saved at the edges of the battery cells 10.

FIG. 7 shows a mechanical connection of a cell connector 100 to a cell connector 210; this mechanical connection is made via the electrical insulator 130. The fixation of the two cell connectors 110, 210 is effected via the integral molding or back-injection in a certain region and once again by means of corresponding recesses 115 and protrusions 135. The cell connector 110 fits over the cell connector 210, and the contact portion 116 is superimposed on the contact portion 212. Between them is the electrical insulator 130, so that no short circuit between the two cell connectors 110, 210 can develop. The contact portion 116 can be adjoined for instance by a tab, not shown in FIG. 7, to which in turn the cord 300, a cell connector 110, 210, or a battery cell 10 can be electrically connected.

The foregoing relates to preferred exemplary embodiments of the invention, it being understood that other variants and embodiments thereof are possible within the spirit and scope of the invention, the latter being defined by the appended claims.

We claim:

1. A rechargeable battery for handheld electromechanical tools, comprising:
a plurality of battery cells;
a plurality of substantially flat electrical cell connectors electrically connecting the plurality of battery cells;
a region of the rechargeable battery in which two of the cell connectors overlap, one of the two overlapping cell connectors being a cell connector of an electrical cell bypass, and
an electrical insulator being fixed to the cell connector of the electrical cell bypass in said region.

2. The rechargeable battery as defined by claim 1, wherein the electrical insulator is provided in a center portion of the cell connector of the cell bypass and on only one side of the cell connector.

3. The rechargeable battery as defined by claim 1, wherein the cell bypass has a first contact portion, by means of which the cell connector is electrically connected to one pole of the rechargeable battery.

4. The rechargeable battery as defined by claim 2, wherein the cell bypass has a first contact portion, by means of which the cell connector is electrically connected to one pole of the rechargeable battery.

5. The rechargeable battery as defined by claim 1, wherein the cell bypass has a second contact portion, by means of which the cell connector is electrically connected to one pole of the rechargeable battery or to a cord.

6. The rechargeable battery as defined by claim 2, wherein the cell bypass has a second contact portion, by means of which the cell connector is electrically connected to one pole of the rechargeable battery or to a cord.

7. The rechargeable battery as defined by claim 3, wherein the cell bypass has a second contact portion, by means of which the cell connector is electrically connected to one pole of the rechargeable battery or to a cord.

8. The rechargeable battery as defined by claim 4, wherein the cell bypass has a second contact portion, by means of which the cell connector is electrically connected to one pole of the rechargeable battery or to a cord.

9. The rechargeable battery as defined by claim 3, wherein the first contact portion and/or the second contact portion of the cell connector is embodied as a tab, which tab is preferably bent out of a plane parallel to the rest of the cell connector and preferably toward a battery cell.

10. The rechargeable battery as defined by claim 4, wherein the first contact portion and/or the second contact portion of the cell connector is embodied as a tab, which tab is preferably bent out of a plane parallel to the rest of the cell connector and preferably toward a battery cell.

11. The rechargeable battery as defined by claim 5, wherein the first contact portion and/or the second contact portion of the cell connector is embodied as a tab, which tab is preferably bent out of a plane parallel to the rest of the cell connector and preferably toward a battery cell.

12. The rechargeable battery as defined by claim 6, wherein the first contact portion and/or the second contact portion of the cell connector is embodied as a tab, which tab is preferably bent out of a plane parallel to the rest of the cell connector and preferably toward a battery cell.

13. The rechargeable battery as defined by claim 7, wherein the first contact portion and/or the second contact portion of the cell connector is embodied as a tab, which tab is preferably bent out of a plane parallel to the rest of the cell connector and preferably toward a battery cell.

14. The rechargeable battery as defined by claim 8, wherein the first contact portion and/or the second contact portion of the cell connector is embodied as a tab, which tab is preferably bent out of a plane parallel to the rest of the cell connector and preferably toward a battery cell.

15. The rechargeable battery as defined by claim 2, wherein the electrical insulator in the center portion of the cell bypass is embodied as a securing portion, by means of which the cell bypass is seated on a first battery cell.

16. The rechargeable battery as defined by claim 1, wherein the electrical insulator of the cell bypass extends around a contact portion of the cell connector; and the contact portion of the electrical insulator is embodied as a securing portion, by means of which the cell bypass is seated on a second battery cell.

17. The rechargeable battery as defined by claim 1, wherein the electrical insulator of the cell bypass, on a side remote from the cell connector, has a recess for a cell connector, or has a contact portion of a cell connector.

18. The rechargeable battery as defined by claim 1, wherein the electrical insulator comprises a plastic and is integrally injection-molded onto the cell connector, preferably being at least partially extrusion-coated or back-injected.

19. An electromechanical tool, in particular a cordless screwdriver, power drill, circular saw, jigsaw, power sander, or garden tool, having a rechargeable battery as defined by claim 1.
